(19) United States
(12) Patent Application Publication
(10) Pub. No.: US 2009/0012909 A1
(43) Pub. Date: Jan. 8, 2009

(54) MANAGING RISK ASSOCIATED WITH OWNERSHIP OF SHARES IN A COMPANY

(75) Inventors: Mordokhi Shniberg, Elkana (IL); Dan Galai, Jerusalem (IL)

Correspondence Address: FISH & RICHARDSON P.C., P.O. BOX 1022, MINNEAPOLIS, MN, 55440-1022, US

(73) Assignee: MTS Investments, Inc., New York, NY (US)

(21) Appl. No.: 11/574,945

(22) PCT Filed: Aug. 5, 2005
(86) PCT No.: PCT/US2005/027736

§ 371 Date: Sep. 24, 2008

Related U.S. Application Data
(60) Provisional application No. 60/599,008, filed on Aug. 5, 2004.

(51) Int. Cl. G06Q 40/00

(52) U.S. Cl. 705/36 R; 705/37

(57) ABSTRACT

A method of managing risk associated with ownership of shares in a company includes accepting shares for pooling into a collective investment fund. One or more financial instruments are issued in exchange for shares. Revenues are generated on behalf of the collective investment fund through realization of accepted shares. A portion of those revenues is distributed among the shareholders according to vested interests in the financial instruments held by the shareholders independent of whether the revenues were generated from the shares accepted from that particular shareholder.

### TECHNICAL FIELD

The present disclosure relates to financial engineering, and specifically to managing risk associated with ownership of shares in a company.

### BACKGROUND

Venture capital investments are characterized by high-returns and high-risk. Hence, founders and shareholders of start-up companies are exposed to high risk while their investment, for an extended period of time, is illiquid.

Shareholders of companies, especially in early-stages of life, are often unable to sell their shares in the company even though the company's shares have economic value. This is due to the fact that the company is usually still private and the stocks are not publicly traded. In addition, the company is expected to appreciate in value and, therefore, current realization of the shares is not optimal at an early stage. Furthermore, companies, especially in their early-stages, suffer from uncertainty regarding their future value. The present disclosure aims to address these issues.

### SUMMARY

The present disclosure relates to a method that allows an individual shareholder to liquidate his or her shares in a company partially, while maintaining an opportunity to enjoy future appreciation in the value of the shares. The method also enables shareholders to reduce risk associated with share ownership by diversifying their investment through participation in a collective investment fund. Moreover, the method provides a highly leveraged investment opportunity for investors.

As explained in greater detail below, according to one implementation, particular companies are selected to participate in a fund. Shareholders (including company founders) in the selected companies may sell part or all of their holdings to the fund. In exchange for each share that is offered and accepted into the fund, the shareholder receives one or more financial instruments based, for example, on the current value of the company (as evaluated by the market or by the fund). The shares, which become owned by the fund, generate income for the fund at a later date, for example, through the sale of those shares.

In one implementation, the financial instrument(s) that the shareholder receives in exchange for his or her shares may include both a liquid asset (e.g. cash) and a percentage of future revenues generated by the fund. The liquid asset's value is a portion of the value of the shares that shareholder sells to the fund. In exchange for the shareholder's foregoing receipt of immediate full compensation for the shares sold to the fund, the shareholder receives a future income stream that may be based, in part, on the appreciation of the shares sold by that shareholder and based, in part, on the success of the fund's entire portfolio.

In one aspect, a method of managing risk associated with ownership of shares in a company includes accepting from shareholders company shares to be pooled in a collective investment fund that includes shares from multiple companies. One or more financial instruments are issued in exchange for the accepted company shares. Revenues are generated on behalf of the collective investment fund through realization of the accepted company shares. A portion of those revenues is distributed among the shareholders according to vested interests in the financial instruments held by the shareholders.

In certain implementations, the method also includes issuing liquid capital in exchange for the accepted company shares. The issued liquid capital typically has a value that is less than an estimated value of the accepted company shares. The value may be, for example, between approximately 20% and 60% of the accepted company shares' estimated value.

According to one implementation, the method also includes liquidating a portion of the accepted company shares from a particular shareholder to generate liquidation revenues. A first part of those liquidation revenues is disbursed to that shareholder and a second part of those liquidation revenues is allocated into a pooled account for disbursement among all participating shareholders in fund.

In another aspect, a system for distributing revenues in connection with a collective investment fund includes a shareholder database storing information about shares accepted from multiple shareholders by a collective investment fund in exchange for one or more financial instruments, a generated revenues database storing information about revenues generated on behalf of the collective investment fund through realization of the accepted shares and a processor coupled to each database and adapted to cause distribution of a portion of the revenues among the shareholders according to a vested interest in the one or more financial instruments held by each shareholder. Some implementations of the system include distributing the revenues to the shareholders electronically.

In certain implementations, the processor is adapted to determine the vested interest held by each shareholder based on an appreciation of the shares accepted from that particular shareholder, individually. In certain implementations, the processor is adapted to determine the vested interest held by each particular shareholder based on an appreciation of the shares accepted from all of the shareholders, collectively.

In various implementations, one or more of the following advantages may be present. Shareholders, particularly of young companies, may realize significant benefits by participating in a fund implementing the techniques disclosed herein.

For example, by entering such a fund, the shareholder receives cash immediately. That may be particularly desirable for a shareholder of a young company where the shares would otherwise be illiquid for an uncertain, and potentially extended, period of time. Receipt of immediate cash might be used by that shareholder to further develop the company thereby increasing the possibility of the company ultimately realizing success. Additionally, the immediate receipt of cash might reduce the stress that a shareholder experiences with respect to share ownership in a young company with an uncertain future.

Additionally, through participation in the fund, the shareholder minimizes risk of share ownership by diversifying his or her investment. That is because each shareholder receives a portion of the revenues generated on behalf of the fund and that portion may be based on both the performance of shares from that particular shareholder and based on the fund's overall performance (i.e. based on generating revenues from the shares in all the companies held by the fund). Accordingly, the possibility that a participating shareholder will completely lose his or her investment is unlikely.

The receipt of an immediate cash disbursement and the reduction of risk may provide shareholders with lower overall stress and, therefore, improved health.

From the point of view of investors in the fund, the techniques described herein may result in an investment tool that offers the possibility of high returns coupled with low risk. That is due to the leverage that can be realized through implementing the techniques disclosed herein and the high level of diversification of investments held by the fund. Specifically, since shares are purchased at a cost that is lower than the shares' current value, the investor's essentially receive more shares than they pay for. Also a fund that incorporates the techniques described herein may be able to operate with low management costs, which would be desirable to investors.

A person of ordinary skill may recognize other feature and advantages from the detailed description, the accompanying drawings, and the claims.

### BRIEF DESCRIPTION OF THE DRAWINGS

FIG. 1 illustrates an example of an enterprise including a fund for reducing risk in ownership of shares in a company.

FIG. 2 is a flowchart illustrating a particular implementation of a fund's operations.

FIG. 3 is table illustrating a particular implementation of a revenue distribution technique for a fund.

FIG. 4 is a timeline for a particular implementation of a fund's operations.

FIG. 5 is a table detailing a particular implementation of a fund's operations under a particular set of circumstances.

FIG. 6 is an example of a system for the disbursement of revenues generated by a fund.

Like reference numerals refer to like elements.

### DETAILED DESCRIPTION

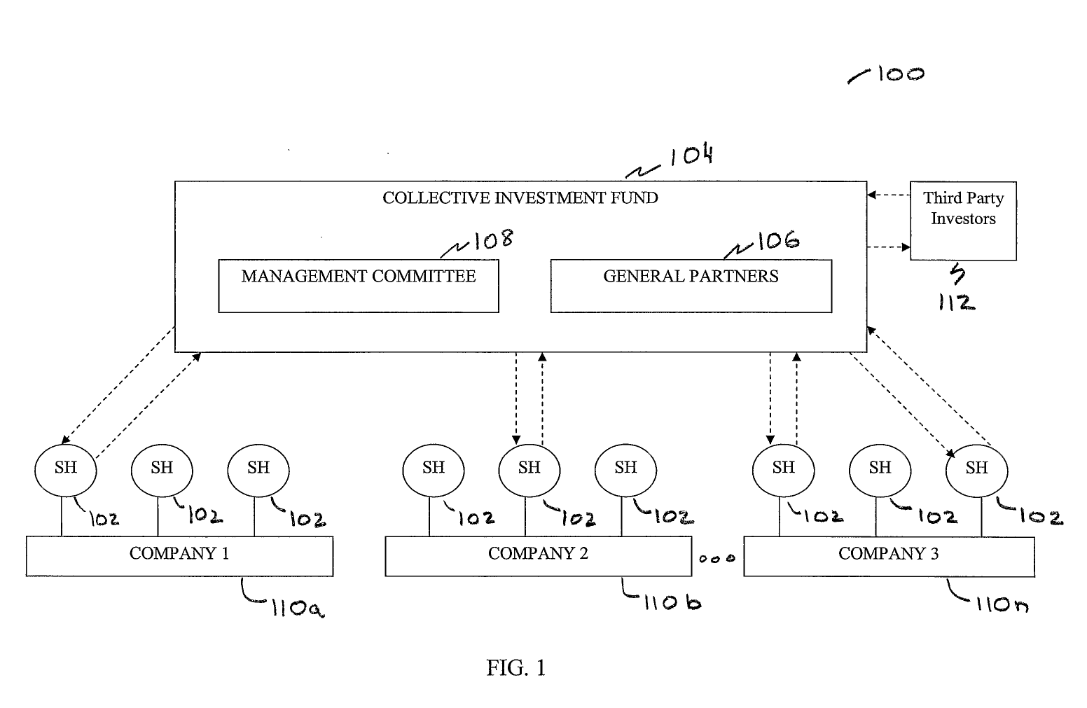

FIG. 1 illustrates an exemplary enterprise 100 through which shareholders 102 of different companies can pool some or all of their shares into a collective investment fund 104. The illustrated fund 104 includes general partners 106 for directing the fund 104, and a management committee 108 for handling day-to-day operations of the fund 104. The enterprise 100 also includes several companies 110a, 110b . . . 110n that have been selected for participation in the fund 104. Each company 110a, 110b . . . 110n includes at least one shareholder 102 who sells shares to the fund 104. Third-party investors 112 provide financing to operate the fund 102.

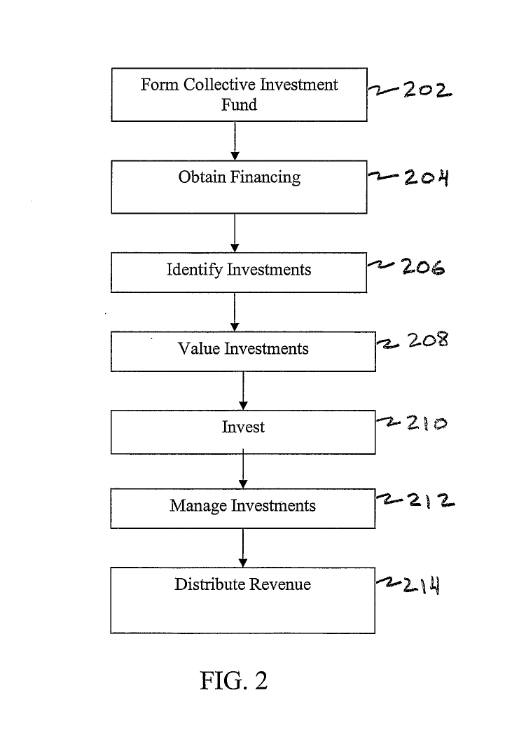

FIG. 2 is a flowchart illustrating a particular implementation of operating a collective investment fund 104. The illustrated method includes forming 202 the fund 104 and obtaining 204 financing to operate the fund 104. According to one implementation, the fund 104 is formed as a limited partnership.

The fund 104 can obtain financing from both institutional and private investors 112. The finances obtained can be used to purchase shares from shareholders 102 and to support fund operations. From an investor's 112 perspective, the fund 104 provides a well leveraged investment tool. That leverage is realized through the purchase of shares at a lower cost than the market value of those shares and making up the difference with possible future income that is dependent on performance of the purchased shares and the fund 104 overall. If financing is secured before the fund 104 is ready to begin investing in companies 110a, 110b . . . 110n, those secured finances may be temporarily invested in short-term, low risk, high quality investments.

The illustrated method also includes identifying 206 investments for the fund 104. That task is performed by the fund's management committee 108. The general investment objectives for the fund 104 include generating a high return and creating a diversified portfolio.

According to one implementation, the management committee 108 identifies investments by selecting leading venture capital funds (hereinafter “VCFs”) to act as the fund's investment “selection committee.” Leading VCFs typically are skilled in identifying favorable investments opportunities, and companies that receive VCF funding are often a good investment.

Utilizing such an approach helps ensure that sound investment choices are made with minimal involvement from the management committee 108. Also, by considering the investment choices of several different VCFs, the management committee 108 can ensure that the fund's investment portfolio is diverse. According to one implementation, the management committee 108 selects between ten and twelve leading VCF's to guide their investment decisions.

According to another implementation, members of the management committee 108 either conduct or commission detailed market analysis to identify desirable investments for the fund 104.

The fund 104 also may accept applications for participation in the fund 104 from shareholders of unselected companies that are interested in participating in the fund 104. In some instances, the management committee 108 may extend an invitation to shareholders of such companies to submit an application for participation in the fund 104. The management committee 108 examines such applications in accordance with a set of predetermined guidelines.

The fund 104 may also use other guidelines in making investment decisions. Under a certain implementation of those guidelines, the fund 104 might set a limit on the number of shares it will buy from any one shareholder. For example, the fund 104 might refuse to purchase more than 30% of any particular shareholder's holdings in a company. Such a restriction might be desirable where, for example, a VCF investing in the company might choose to invest elsewhere if it is believed that the shareholder's interest in the success of a company is compromised.

According to another implementation, the fund 104 might limit its holdings in any one company to not more than 25% of its portfolio. Such a limitation might be desirable to ensure a sufficient amount of diversification among the fund's holdings.

Prior to actually purchasing shares, the management committee 108 values 208 those shares. A variety of approaches are possible for determining such value. According to one approach, the shares are valued based on the shares' trading value in the marketplace. According to another approach, the shares of are valued based on a valuation during a VCF funding round for the company. To illustrate, assume that a selected VCF invests in a particular company, which it values at $10,000,000. Assume also that, after the VCF investment, one of company's shareholders owns 20% of the company. Under the latter valuation approach, the fund 104 might value that shareholder's shares at $2,000,000 (i.e. 20% of $10,000,000).

Valuation of shares also may take into consideration the type of share being considered. For example, preferred shares might be valued at 100% of the value determined by the VCF while common shares might be valued at 80% of the value determined by the VCF.

After valuing potential investments, the fund 104 invests 210 its financial resources in shares. The amount of money that the fund 104 can invest generally depends on the amount of money that has been received from its investors 112. The management committee 108 approves all investments by the fund.

To initiate an investment, the fund 104 offers to purchase shares from shareholders 102 of a selected company 110a, 110b . . . 110n in exchange for one or more financial instruments. According to one implementation, those financial instruments include liquid asserts (e.g. cash) having a value equal to a portion of the shares' estimated value and participation notes that entitle the participating shareholder 102 to receive a portion of the fund's 104 future revenues (based on the performance of the entire pool of shares in the fund, and in some cases based also on the performance of the particular shares contributed by that shareholder). In a particular situation, for example, to purchase a set of shares, the fund 104 may offer to pay 40% of the shares' value in cash and offer to pay the remaining 60% of the shares' value in participation notes.

In an exemplary transaction, the fund 104 might offer to purchase shares valued at $400,000 from a particular shareholder 102. The offer might include paying the shareholder $160,000 in cash (i.e. 40% of $400,000) and $240,000 in participation notes (i.e. 60% of $400,000).

The fund 104 may continue purchasing shares until substantially all of its financial resources have been used to purchase shares. If, for example, the fund 104 secures $30,000,000 from its investors, it would be able to purchase shares worth approximately $75,000,000 and distribute participation notes worth approximately $45,000,000.

The illustrated method also includes managing 212 the fund's investments. Generally, the fund's management committee 108 manages the fund 104 and its investments throughout the life of the fund. Exemplary management functions include tracking the progress of the fund's investments, periodically informing the fund's investors 112 and shareholders 102 of the fund's performance, liquidating the fund's shares and distributing revenue generated by those liquidations. In order to support those and other functions, the fund 104 may charge a management fee. According to one implementation, the management fee is not higher than about 1.5% of the fund's commitments annually.

The illustrated method also includes distributing 214 revenue earned through liquidation of the fund's shares. Whenever the liquidation of shares results in revenue for the fund 104, that revenue is distributed among vested investors, shareholders and/or general partners according to a predetermined distribution method.

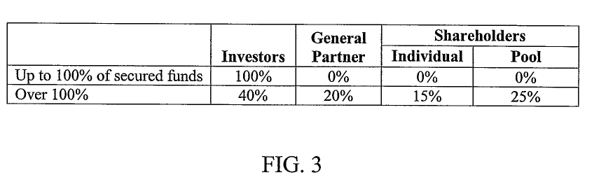

FIG. 3 illustrates an exemplary revenue distribution scheme that the fund 104 might implement. According to the illustrated method, investors 112 in the fund 104 are the first parties to receive distributions. In a particular implementation, each time the fund 104 liquidates shares, the investors 112 receive 85% of the revenue generated by that liquidation. That 85% may be divided among the investors, for example, based on each investor's 112 capital contribution to the fund 104. The additional 15% of revenue generated by each liquidation may be used, for example, to supplement fund 104 management costs. According to the illustrated distribution method, neither the general partners 106 nor the shareholders 102 receive any portion of revenues until the investors 112 have been reimbursed completely for their original capital contributions.

After the investors 112 have been reimbursed for their original capital contributions to the fund 104, any revenue generated by the fund 104 is distributed according to a different method. As illustrated, the investors 112 then receive 40%, the general partners 106 receive 20% and the shareholders 102 receive 40% of any subsequent revenues generated by the fund 104. In some implementations, each shareholder 102 receives revenues based on the performance of the shares that particular shareholder 102 sold to the fund and based on the performance of the fund's collective holdings. Distribution to the shareholders 102 may be at least partially based on the proportion of outstanding participation notes held by each shareholder 102.

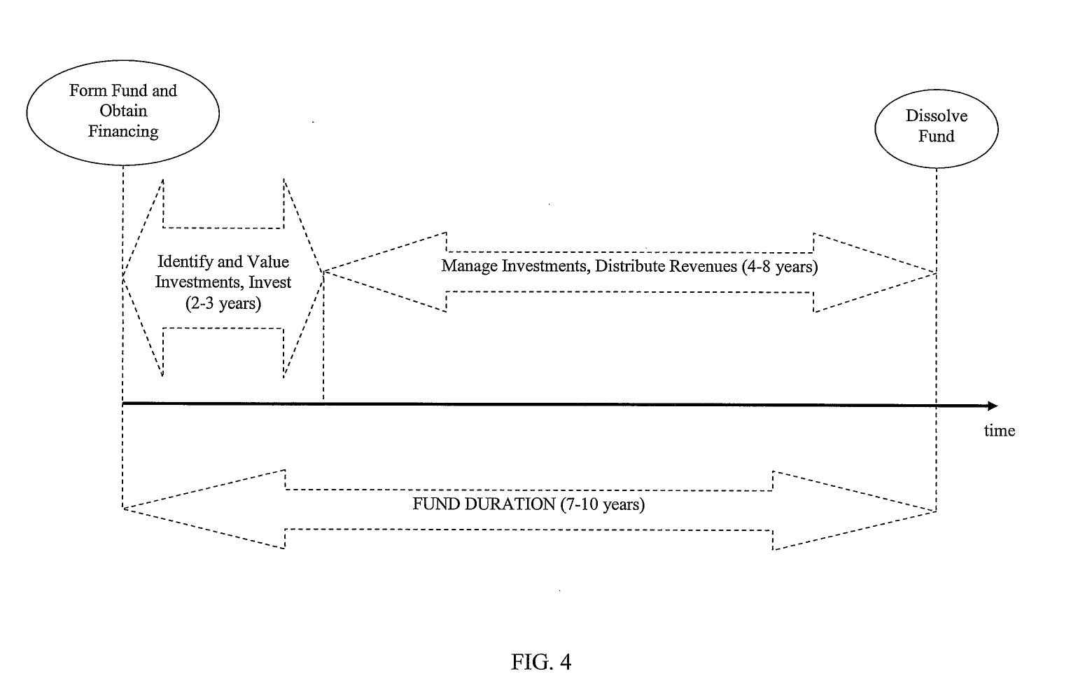

FIG. 4 illustrates a specific example in which the lifetime of the fund 104 is set between seven and ten years. In this particular example, the fund 104 makes all of its investments (i.e., purchasing shares from shareholders) within its first two to three years of its existence. After the first two to three years, the fund 104 is closed to the purchase of additional shares. During the next four to eight years, the fund 104 manages its investments, which includes eventually liquidating its holdings and distributing revenues according to a predetermined distribution method. In this case, after seven years, the fluid 104 is dissolved.

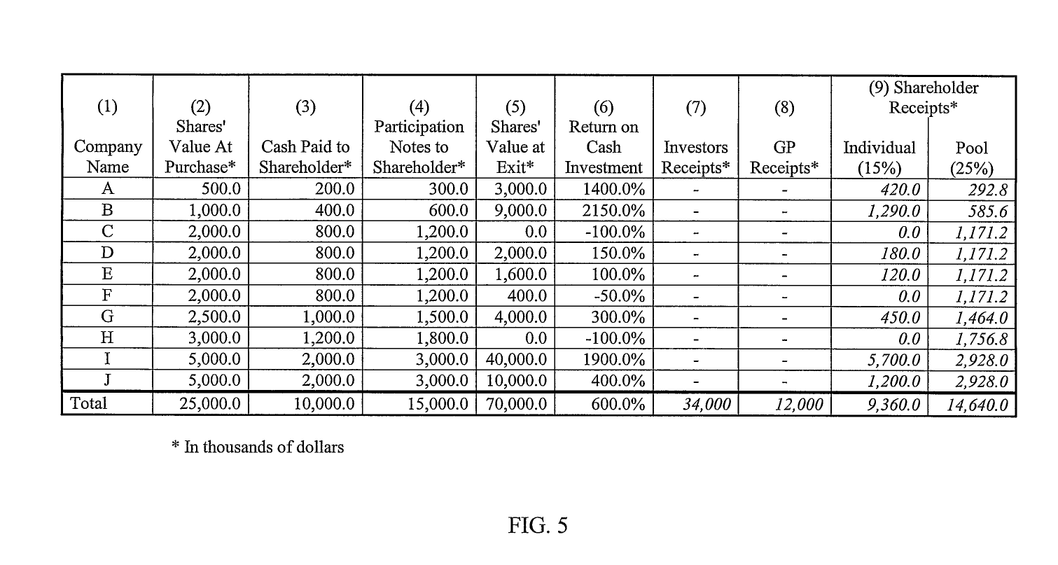

FIG. 5 is a table detailing a particular revenue distribution method under a particular set of circumstances. According to the illustrated implementation, the fund 104 has secured capital contributions from investors 112 amounting to $10,000,000. That $10,000,000 has been invested in ten different companies (identified as companies A to J). For simplicity, it is assumed that each company (A to J) has only one participating shareholder 102. Column (2) shows an estimated value of the share from each company (A to J) when they were purchased by the fund 104. Those estimated values are based on the price per share in the latest round of fund raising for those companies.

Column (3) shows the cash that was paid to shareholders of each company for their shares. The cash paid is equal to 40% of the shares' estimated value at purchase (column (2)). Column (4) shows the participation notes given to shareholders of each company for their shares. The value of those participation notes is 60% of the shares' estimated value at purchase (column (2)).

Column (5) shows the value of each company's shares at liquidation. Column (6) shows the revenues generated for each liquidation as a percentage of the estimated value of the fund's 104 initial investment. The percentages shown in column (6) are calculated using the formula: [column 5−column 2]/column 2.

Columns (7) and (8) show the total amount of revenue received by the investors 112 and the general partners 106 based on liquidation of all the fund's assets. For simplicity, only the total funds are shown without a breakdown of how those funds are attributable to each liquidation.

Column (9) shows the revenue received by the shareholders 102 based on the performance of the company shares from individual shareholders (“Individual”) and based on the collective performance of the entire pool of shares (“Pool”).

Considering a particular one of the examples illustrated in FIG. 5, one shareholder 102 sold shares worth $500,000 in company A. In exchange, that shareholder 102 received $200,000 in cash (i.e. 40% of $500,000) and an additional $300,000 in participation notes (i.e. 60% of $500,000). At a later time, the fund sold those shares for $3,000,000, realizing a return of $2,800,000 (or 1400%) above its initial $200,000 cash investment.

After reimbursing its investors 112 for the initial $200,000 investment, the shareholder 102 received an additional 15% of the revenues generated from liquidation of the shares that the particular shareholder 102 sold to the fund (i.e. 15% of $2,800,000, or $420,000).

In addition, the particular shareholder 102 received a portion of the revenues based on the percentage of participation notes in the fund 104 that that shareholder held. According to the illustrated example, 25% (or $14,640,000) of the total revenue generated by the fund 104 was allocated to the “pool.” The shareholder 102 from company A held 2% of the participation notes issued by the fund 104 (i.e. 300,000 participation notes is 2% of 15,000,000). Therefore, the shareholder 102 from company A received 2% of the revenue that was allocated to the pool. Since the total revenue allocated to the pool was $14,640,000, the shareholder 102 from company A received $292,800 (or 2% of $14,640,000).

In the foregoing example, the shareholder from company A received total compensation of $912,800 (i.e. $200,000+$420,000+$292,800=$912,800) in exchange for his or her initial investment of shares worth $200,000.

As another example, the shareholder from Company H initially sold shares worth $3,000,0000 to the fund. Although those shares eventually became worthless and the fund realized a complete loss of its investment from those shares, the shareholder 102 from Company H received $2,956,800 from the fund 104. Since the shareholder 102 from company H held a large percentage of the participation notes issued by the fund 104, that shareholder 102 was entitled to receive a large portion of the pooled revenues of the fund 104.

According to the particular example illustrated, investors 112 in the fund 104 received their initial investments plus an additional 40% of the revenues generated by the fund 104 after all of the investors 112 were reimbursed for their initial investments. In the illustrated example, the investors received $34,000,000 based on their initial investment of 10,000,000.

According to the distribution method represented in the illustrated table, after the investors 112 were reimbursed completely for their initial capital contributions, general partners 106 in the fund 104 received 20% of the revenues generated by the fund 104. In the particular example illustrated, the general partners 106 received $12,000,000.

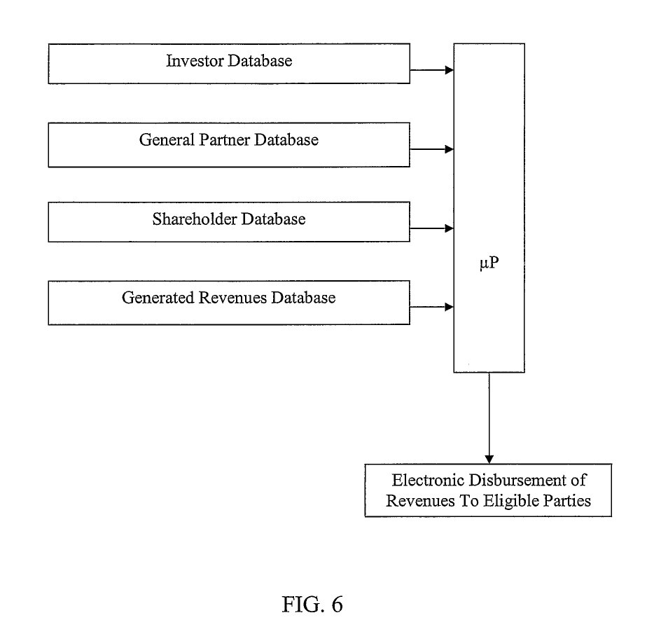

FIG. 6 illustrates an example of a system 600 for the disbursement of revenues to which participating shareholders, investors and general partners are entitled based on the financial instruments issued to them in exchange for their selling shares to the fund 104.

As illustrated, the system 600 includes an investor database 602 to store information regarding each investor in the fund 104. The stored information may include (a) the name and address of each investor; (b) the amount invested by each investor; (c) account information for each investor to which revenues may be automatically distributed; and (d) a running total of revenues received by each investor. Other information also may be stored in the investor database 602.

The system 600 also includes a general partner database 604 to store information regarding each general partner of the fund 104. The stored information may include (a) the name and address of each general partner; (b) a running total of revenues distributed to each general partner; and (c) account information for each general partner to which revenues may be automatically distributed. Other information also may be stored in the general partner database 604.

The system 600 also includes a shareholder database 606 to store information regarding the shareholders that have sold shares to the fund 104. The stored information may include (a) the name and address of each shareholder; (b) the name of each company whose shares were purchased from each shareholder; (c) the number of shares sold by each shareholder; (d) the estimated purchase value of each of those shares; (e) cash paid by fund to each shareholder; (e) participation notes sold to each shareholder; (f) percentage of outstanding participation notes held by each shareholder; (g) liquidation value (if known) of each share; (h) a running total of revenues distributed to each shareholder; and (i) account information for each shareholder to which revenues may be automatically distributed. Other information also may be stored in the shareholder database 606.

The system 600 also includes a generated revenues database 608 to store information regarding revenues generated by the fund 104. The stored information may include (a) a running total of all revenues generated by the fund through realization of shares; and (b) a running total of revenues attributable to the shares from each particular shareholder. Other information also may be stored in the generated revenues database 608.

The various databases 602, 604, 606, 608 may by provided either as separate databases or a single database that stores the relevant information.

A computer system (processor) 610 is coupled to the databases 602, 604, 606, 608. The processor 610 is adapted to determine how revenue that is generated on behalf of the fund is to be distributed among the investors, general partners and shareholders. An electronic means 612 is coupled to the processor 610 to cause the disbursement of revenues to appropriate parties. The electronic means may include, for example, communication links to banks or other financial institutions where participants have accounts. The electronic means provides for automated transfer of funds (i.e., monies).

Various modifications may be made to the particular implementations described herein without departing from the spirit and scope of the invention. For example, the various numbers identified herein are examples only and may vary in other implementations. Thus, any of the following may differ in other implementations: the number of shareholders and companies involved, the length of various time periods, the percentages used in the initial financing method, the number and type of financial instruments issued to each shareholder, and the details regarding how the income stream from the realization of the shares is allocated among the shareholders, investors and the fund itself. Additionally, the steps indicated in FIG. 2 may be modified or performed in a different sequence.

Furthermore, a computer system with one or more databases may be provided to calculate and distribute revenues to the shareholders and investors. The databases may store, for example, such information as the names of the companies that participate in the fund and other investors, the initial value of each share accepted by the fund, the number and value of financial instruments issued to each shareholder and other investor, the net liquidation value of each share, and various other information related to the calculation and distribution of revenues.

Various aspects of the system may be implemented in hardware, software or a combination of hardware and software. Circuitry, including dedicated or general-purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

Various implementations may include some or all of the features discussed above in different combinations.

Other implementations are within the scope of the following claims.

What is claimed is:

1. A method of managing risk associated with ownership of shares in a company, the method comprising:
accepting shares in a plurality of companies from shareholders, wherein the accepted shares are pooled in a collective investment fund;
issuing at least one financial instrument to each particular shareholder in exchange for the company shares accepted from the particular shareholder;
generating revenues on behalf of the collective investment fund through realization of the accepted company shares; and
distributing a portion of the revenues among the shareholders according to vested interests in the financial instruments held by the shareholders, wherein at least a portion of the revenues distributed to each particular shareholder is independent of whether the revenues were generated from the shares accepted from that particular shareholder.

2. The method of claim 1 further comprising issuing liquid capital to each particular shareholder in exchange for the shares accepted from that shareholder, wherein the liquid capital has a value less than an estimated present value of the shares accepted from that shareholder.

3. The method of claim 2 wherein the liquid capital has a value between approximately 20% and 60% of the accepted company shares' estimated present value.

4. The method of claim 1 further comprising reimbursing investors from the generated revenues prior to distributing a portion of the revenues among the shareholders.

5. The method of claim 1 further comprising:
liquidating a portion of the accepted shares from a particular one of the shareholders to generate liquidation revenues;
distributing a first part of the liquidation revenues to the particular one of the shareholders; and
distributing a second part of the liquidation revenues among all the shareholders in the fund.

6. The method of claim 5 comprising disbursing the second part of the liquidation revenues among the shareholders based on percentages dictated by the financial instruments issued to each shareholder.

7. The method of claim 1 wherein distributing the portion of the revenues comprises electronically distributing the portion of the revenues.

8. The method of claim 1 comprising determining the vested interest in the financial instruments held by a particular one of the shareholders based on an appreciation in value of the company shares accepted from the particular one of the shareholders.

9. The method of claim 1 comprising determining the vested interest in the financial instruments held by a particular one of the shareholders based on an appreciation in value of the company shares accepted from all of the shareholders, collectively.

10. The method of claim 1 comprising selecting companies for participation in the collective investment fund.

11. The method of claim 10 wherein selecting the companies for participation comprises identifying companies that have received funding from a venture capital firm.

12. The method of claim 10 wherein selecting the companies for participation comprises identifying companies whose shares are substantially illiquid.

13. The method of claim 10 wherein selecting the companies for participation comprises identifying companies whose shares are expected to generate revenue within about five to seven years.

14. A system for distributing revenues in connection with a collective investment fund, the system comprising:
a shareholder database storing information about shares accepted from shareholders by a collective investment fund in exchange for one or more financial instruments;
a generated revenues database storing information about revenues generated on behalf of the collective investment fund through realization of the accepted shares; and
a computer system coupled to each database and adapted to cause distribution of a portion of the revenues among the shareholders according to a vested interest in the one or more financial instruments held by each shareholder, wherein at least a portion of the revenues distributed to each particular shareholder is independent of whether the revenues were generated from the shares accepted from that particular shareholder.

15. The system of claim 14 wherein the computer system is adapted to cause the portion of the revenues to be distributed electronically among the shareholders.

16. The system of claim 14 wherein the computer system is adapted to determine the vested interest held by a particular shareholder based on an appreciation in value of the shares accepted from the particular shareholder.

17. The system of claim 14 wherein the computer system is adapted to determine the vested interest held by each particular shareholder based on an appreciation in value of the shares accepted from all of the shareholders, collectively.

18. The system of claim 14 comprising an investor database storing information about investors in the collective investment fund, wherein the computer system is adapted to cause distribution of a portion of the revenues to reimburse the investors from generated revenues prior to distributing a portion of revenues among the shareholders.

19. The system of claim 18 wherein the computer system is adapted to cause the portion of the revenues to be distributed electronically to the investors.

20. The system of claim 14 comprising a general partner database storing information about general partners in the collective investment fund, wherein the computer system is adapted to cause distribution of a portion of the revenues to the general partners.

21. The system of claim 20 wherein the computer system is adapted to cause the portion of the revenues to be distributed electronically to the general partners.

22. The system of claim 14 wherein the computer system is adapted to track whether each investor has been reimbursed for their respective capital contributions to the collective investment fund and to distribute revenue to the shareholders only after reimbursing the investors for their initial investment in the fund.

23. The system of claim 14 wherein upon a liquidation of a portion of the accepted shares from a particular one of the shareholders to generate liquidation revenues, the computer system is adapted to:
distribute a first part of the liquidation revenues to the particular one of the shareholders; and
distribute a second part of the liquidation revenues among all the shareholders in the fund.
